(19) United States
(12) Patent Application Publication
(10) Pub. No.: US 2026/0049847 A1
(43) Pub. Date: Feb. 19, 2026

(54) INTEGRATED CIRCUIT FOR REDUNDANT INDUCTIVE SENSOR COILS

(71) Applicant: Renesas Electronics America Inc., Milpitas, CA (US)

(72) Inventors: Serge Di Matteo, Düsseldorf (DE); Faranak Pourdanesh, Düsseldorf (DE); Rudolf Pichler, Dresden (DE); Simon Paul Höfler, Dresden (DE)

(73) Assignee: Renesas Electronics America Inc., Milpitas, CA (US)

(21) Appl. No.: 18/805,651

(22) Filed: Aug. 15, 2024

(51) Int. Cl. G01D 5/20

(52) U.S. Cl. CPC G01D 5/2053; G01D 2205/26

(57) ABSTRACT

Systems for inductive positioning sensing are described. A transmission coil can generate a magnetic field. A first set of receiver coils can pick up first voltage signals from the magnetic field. A second set of receiver coils can pick up second voltage signals from the magnetic field. The first and second inductive sensors can have a fixed relation. An integrated circuit (IC) can multiplex the first and second voltage signals to process one of the first and second voltage signals using one channel at a time. The IC can convert the first voltage signals into a first digital parameter and convert the second voltage signals into a second digital parameter. The IC can output the first and second digital parameters to trigger at least one plausibility checker to determine whether the first angle position and the second angle position satisfy or fail to satisfy the fixed relation.

### BACKGROUND

The present disclosure relates to integrated circuits for inductive position sensors, in particular, a single integrated circuit for redundant inductive position sensors.

Inductive position sensors implement a magnet-free technology, utilizing the physical principles of eddy currents or inductive coupling to detect the position of a conductive target that is moving above a set of coils that can include, for example, one transmitter coil and two receiver coils. The three coils are arranged such that the transmitter coil induces a secondary voltage in the two receiver coils, and the secondary voltage can change when the position of the target relative to the receive coils changes. The secondary voltage can be picked up by the receiver coils and can be provided by the receiver coils to a processing element. The processing element can use the secondary voltage to determine a position of the conductive target and if a physical component is attached to the conductive target, the position of the physical component can be determined as well.

### SUMMARY

In one embodiment, a system for inductive position sensing is generally described. The system can include a conductive target and a transmission coil configured to generate a magnetic field. The system can further include a first inductive sensor including a first set of receiver coils configured to pick up a set of first voltage signals from the magnetic field. The set of first voltage signals can indicate a first angle position of the conductive target that varies with movement of the conductive target. The system can further include a second inductive sensor including a second set of receiver coils configured to pick up a set of second voltage signals from the magnetic field. The set of second voltage signals can indicate a second angle position of the conductive target that varies with movement of the conductive target. The first inductive sensor and the second inductive sensor can be related based on a fixed relation. The system can further include an integrated circuit (IC) configured to multiplex the set of first voltage signals and the set of second voltage signals to process one of the set of first voltage signals and the set of second voltage signals using one channel at a time. The IC can be further configured to convert the set of first voltage signals into a first digital parameter. The IC can be further configured to convert the set of second voltage signals into a second digital parameter. The IC can be further configured to output the first digital parameter and the second digital parameter to trigger at least one plausibility checker to determine whether the first angle position and the second angle position satisfy or fail to satisfy the fixed relation.

In one embodiment, an integrated circuit (IC) for inductive position sensing is generally described. The IC can include a multiplexer configured to multiplex a set of first voltage signals and a set of second voltage signals to process one of the set of first voltage signals and the set of second voltage signals using one channel at a time. The set of first voltage signals can be picked up by a first inductive sensor and indicates a first angle position of a conductive target. The set of second voltage signals can be picked up by a second inductive sensor and indicates a second angle position of the conductive target. The first inductive sensor and the second inductive sensor can be related based on a fixed relation. The IC can further include an analog to digital converter (ADC) configured to convert the set of first voltage signals into a first digital parameter and to convert the set of second voltage signals into a second digital parameter. The IC can further include an output interface configured to output the first digital parameter and the second digital parameter to trigger at least one plausibility checker to determine whether the first angle position and the second angle position satisfy or fail to satisfy the fixed relation.

In one embodiment, a computer program product for inductive position sensing is generally described. The computer program product can include a computer readable storage medium having program instructions embodied therewith. The program instructions can be executable by a processor of a device to cause the device to receive a first digital parameter representing a first angle position of a conductive target relative to a first set of receiver coils in a first inductive sensor. The program instructions can be further executable by a processor of a device to cause the device to receive a second digital parameter representing a second angle position of the conductive target relative to a second set of receiver coils in a second inductive sensor. The program instructions can be further executable by a processor of a device to cause the device to, in response to receipt of the first digital parameter and the second digital parameter, execute a set of instructions to run at least one plausibility checker to determine whether the first angle position and the second angle position satisfies a fixed relation between the first inductive sensor and the second inductive sensor. The first angle position and the second angle position satisfying the fixed relation can indicate the first angle position and the second angle position are correct. The first angle position and the second angle position failing to satisfy the fixed relation can indicate one or more of the first angle position and the second angle position are incorrect.

The foregoing summary is illustrative only and is not intended to be in any way limiting. In addition to the illustrative aspects, embodiments, and features described above, further aspects, embodiments, and features will become apparent by reference to the drawings and the following detailed description. In the drawings, like reference numbers indicate identical or functionally similar elements.

### BRIEF DESCRIPTION OF THE DRAWINGS

FIG. 1 is a diagram showing a system that can implement integrated circuit for redundant inductive sensor coils in one embodiment.

FIG. 2A is a diagram showing an example implementation of integrated circuit for redundant inductive sensor coils in one embodiment.

FIG. 2B is a diagram showing an example set of redundant coils in one embodiment.

FIG. 2C is a diagram showing another example set of redundant coils in one embodiment.

FIG. 2D is a diagram showing another example set of redundant coils in one embodiment.

FIG. 3 is a diagram showing details of an integrated circuit for redundant inductive sensor coils in one embodiment.

FIG. 4 is a diagram showing additional details of an integrated circuit for redundant inductive sensor coils in one embodiment.

FIG. 5 is a diagram showing an ASIL D decomposition that can be achieved by integrated circuit for redundant inductive sensor coils in one embodiment.

FIG. 6 is a diagram showing another ASIL D decomposition that can be achieved by integrated circuit for redundant inductive sensor coils in one embodiment.

FIG. 7 is a diagram showing another ASIL D decomposition that can be achieved by integrated circuit for redundant inductive sensor coils in one embodiment.

FIG. 8 is a diagram showing another ASIL D decomposition that can be achieved by integrated circuit for redundant inductive sensor coils in one embodiment.

FIG. 9A is a diagram showing an example of combinations of target position angles for an implementation of redundant inductive sensor coils in one embodiment.

FIG. 9B is a diagram showing an example of combinations of target position angles for another implementation of redundant inductive sensor coils in one embodiment.

FIG. 10A is a diagram showing an example of combinations of target position angles for another implementation of redundant inductive sensor coils in one embodiment.

FIG. 10B is a diagram showing an example of combinations of target position angles for another implementation of redundant inductive sensor coils in one embodiment.

FIG. 11 is a diagram showing an example of combinations of target position angles for another implementation of redundant inductive sensor coils in one embodiment.

### DETAILED DESCRIPTION

In the following description, numerous specific details are set forth, such as particular structures, components, materials, dimensions, processing steps and techniques, in order to provide an understanding of the various embodiments of the present application. However, it will be appreciated by one of ordinary skill in the art that the various embodiments of the present application may be practiced without these specific details. In other instances, well-known structures or processing steps have not been described in detail in order to avoid obscuring the present application.

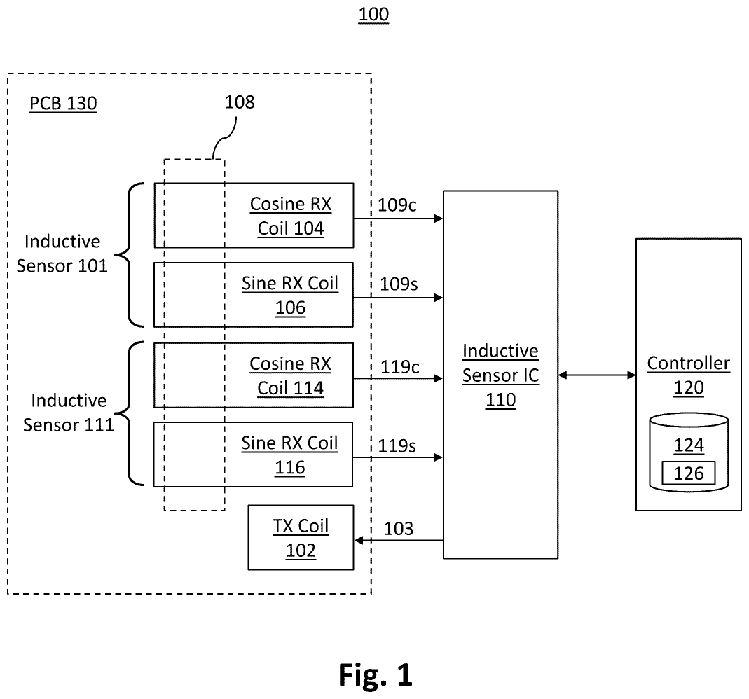

FIG. 1 is a diagram showing a circuit that can implement integrated circuit for redundant inductive sensor coils in one embodiment. System 100 shown in FIG. 1 can be an inductive position sensing system. System 100 can include an inductive sensor integrated circuit (IC) 110, a controller 120, a pair (e.g., two) of inductor sensors 101, 111 and at least one target, such as a target 108. Inductor sensors 101 111 can include coils printed on a printed circuit board (PCB) 130. Target 108 can be a conductive structure composed by conductive materials, such as metal (e.g., aluminum, steel), or a PCB (different from PCB 130) with a printed copper layer. In one embodiment, controller 120 can be an electronic control unit (ECU) of a vehicle's (e.g., autonomous vehicle, non-autonomous vehicle, electric vehicle, hybrid vehicle, gas vehicle, etc.) electronic system configured to manage various aspects such as engine, safety protocols, emergency braking, keyless entry and various mechanisms such as seat adjustments, etc. Example applications of system 100 can include gear lever position sensor, accelerator pedal sensors, brake pedal sensors, steering position sensors, rotor position sensors for motor commutation (traction inverter, Actuators), position sensors for actuators (park lock, transmission, valve, brake).

In one embodiment, controller 120 can include at least one memory 124, that includes volatile memory devices and/or non-volatile memory devices, that can store a set of instructions 126. Instructions 126 can include program code, such as source code and/or executable code, that can be executed by controller 120 to perform one or more tasks described herein. For example, to be described in more detail below, controller 120 can be configured to execute instructions 126 to perform one or more plausibility checks on various aspect of system 100.

Inductive sensor 101 can include at least a pair of receiver (RX) coils including a cosine RX coil 104 and a sine RX coil 106. Cosine RX coil 104 and sine RX coil 106 can be provided as copper traces printed on PCB 130. Inductive sensor 111 can include at least a pair of receiver (RX) coils including a cosine RX coil 114 and a sine RX coil 116. Cosine RX coil 114 and sine RX coil 116 can be provided as copper traces printed on PCB 130. A transmitting (TX) coil 102 can also be printed, as copper traces, on PCB 130.

In one embodiment, inductive sensor IC 110 can be a signal conditioning circuit configured to generate a signal 103 that can be applied to TX coil 102. In one embodiment, signal 103 can be an analog signal such as a radio-frequency (RF) signal. The application of signal 103 on TX coil 102 can cause TX coil 102 to create a first magnetic field by inducing a secondary voltage on cosine RX coil 104 and sine RX coil 106. The secondary voltage can vary as target 108 moves and/or overlaps with cosine RX coil 104 and sine RX coil 106. Cosine RX coil 104 and sine RX coil 106 can pick up the varying secondary voltage of the first magnetic field as target 108 moves and output voltage signals 109c, 109s to inductor sensor IC 110. The amplitude of voltage signals 109c, 109s can vary with the position (e.g., angle position) of target 108 relative to cosine RX coil 104 and sine RX coil 106.

The application of signal 103 on TX coil 102 can also cause TX coil 102 to create a second magnetic field by inducing a secondary voltage on cosine RX coil 114 and sine RX coil 116. The secondary voltage can vary as target 108 moves and/or overlaps with cosine RX coil 114 and sine RX coil 116. Cosine RX coil 114 and sine RX coil 116 can pick up the secondary voltage of the second magnetic field as target 108 moves and output voltage signals 119c, 119s to inductor sensor IC 110. The amplitude of voltage signals 119c, 119s can vary with the position (e.g., angle position) of target 108 relative to cosine RX coil 114 and sine RX coil 116. Cosine RX coil 104, sine RX coil 106, cosine RX coil 114 and sine RX coil 116 can be referred to as receiver coils. In an aspect, inductive sensor IC 110 can determine the position of target 108 based on voltage signals 109c, 109s and/or 119c, 119s. Inductive sensor IC 110 can convert the voltage signals 109c, 109s and/or 119c, 119s into digital signals that can be interpreted and processed by controller 120. Controller 120 can use the digital signals to determine positions of target 108 and/or positions of physical components that may be attached to target to controller 120. Controller 120 can use the determined positions to adjust and/or control various aspects of a vehicle.

In in-vehicle electronic systems compliant with International Standard Organization (ISO) 26262, high safety is required for semiconductor devices mounted on vehicles. Regarding the safety of the in-vehicle electronic systems, levels A to D are specified as Automotive Safety Integrity Level (ASIL), and the highest safety is required in ASIL D. Therefore, there is a need for a semiconductor device that meets ASIL D. In an aspect, ASIL D can be achieved by implementing ASIL C redundancies, such as implementing two copies of a component or IC that achieves ASIL C. For example, a semiconductor device mounted on a vehicle may include inductive position sensors for detecting positions of various physical components of a vehicle. A redundant set of inductive sensors, such as inductive sensors 101, 111, can provide safety mechanism such as a fail-safe in case one of the inductive sensors failed to function or as an extra inductive sensor to check the integrity of the measurements performed by the other inductive sensor. This redundant implementation of inductive sensors can achieve using redundant set of ASIL C compliant components to achieve ASIL D. However, in conventional systems, the redundancy of inductive sensors may also require redundant (e.g., two) signal conditioning ICs to process the voltages picked up by the redundant inductive sensors.

To be described in more detail below, the systems described herein can achieve ASIL D requirements by implementing a single signal conditioning IC, such as inductive sensor IC 110, to process voltages picked up by redundant inductive sensors (e.g., inductive sensors 101, 110). The two receiver coils can remain redundant but one signal conditioning IC can receive the voltages from the redundant receiver coils. The one signal conditioning IC can time multiplex the voltages to process one multiplexed signal using one channel, or one integrated signal path in inductive sensor IC 110, at a time for generating digital parameters that can trigger plausibility checks that can be performed by specific ICs (e.g., plausibility checker) or controller 120. The single inductive sensor IC architecture described herein can achieve ASIL D, without the need of two separate inductive sensor ICs or signal conditioning circuits (e.g., without two ASIL C compliant ICs). Inductive sensor IC 110 can receive the inductive sensor voltages and time multiplex the voltages from the two inductive sensors to separate the voltages. Hence, inductive sensor IC 110 can process the voltages from the two inductive sensors individually-either for measurement purposes or for safety mechanism (e.g., fail safe) purposes, to achieve ASIL D redundancy requirements. In one embodiment, the time multiplexed signals being processed by inductive sensor IC 110 can be provided to controller 120 and controller 120 can perform various plausibility checks. In one embodiment, the time multiplexed signals being processed by inductive sensor IC 110 can be provided to an IC, that can be outside of controller 120 and/or inductive sensor IC 110, for performing the plausibility checks. The inductive sensor IC 110 being implemented for redundancy requirements, and the controller 120 being implemented for plausibility checks, can achieve ASIL D requirements.

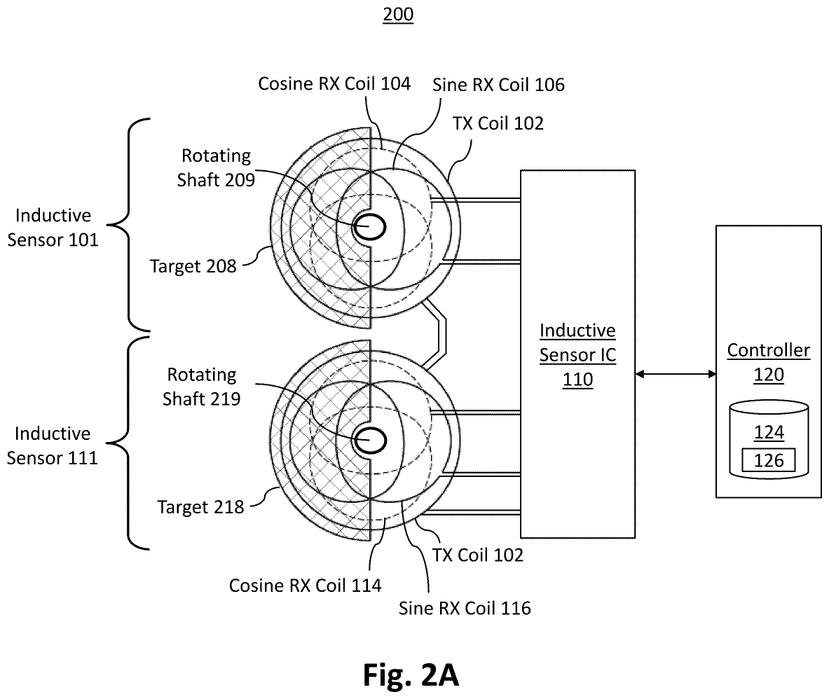

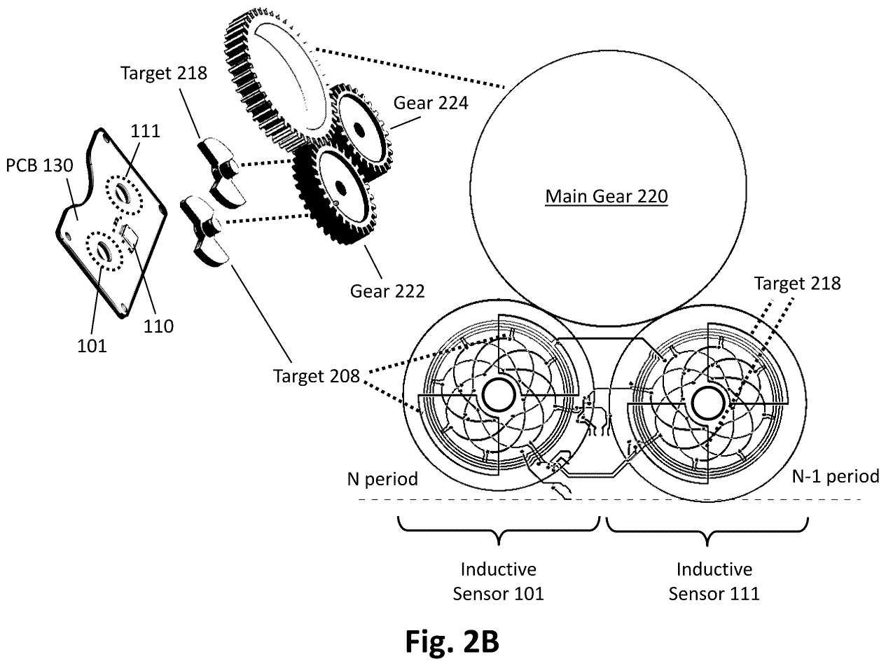

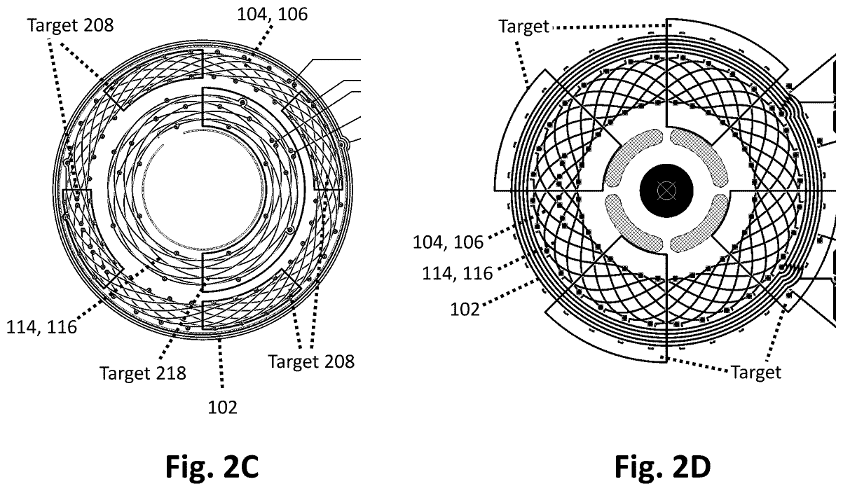

FIG. 2A is a diagram showing an example implementation of integrated circuit for redundant inductive sensor coils in one embodiment. Description of FIG. 2A can reference components shown in FIG. 1. In an embodiment shown in FIG. 2A, inductive sensors 101, 111 can be rotary sensors. Inductive sensor 101 can include a target 208 and a rotary shaft 209. Target 208 can be one of the conductive targets among the at least one target 108 in FIG. 1. In one embodiment, target 208 can rotate around rotary shaft 209. In an example, a physical component of a vehicle can be attached to target 208, such that when an operator of the vehicle moves the physical component, target 208 can move or rotate around rotary shaft 209. The secondary voltage being picked up by cosine RX coil 104 and sine RX coil 106 can change as target 208 moves.

Inductive sensor 111 can include a target 218 and a rotary shaft 219. Target 218 can be one of the conductive targets among the at least one target 108 in FIG. 1. In one embodiment, target 218 can rotate around rotary shaft 219. In an example, a physical component of a vehicle can be attached to target 218, such that when an operator of the vehicle moves the physical component, target 218 can move or rotate around rotary shaft 219. The secondary voltage being picked up by cosine RX coil 114 and sine RX coil 116 can change as target 218 moves. In one embodiment, inductive sensors 101, 111 can be arranged in a vertical stack such that inductive sensors 101, 111 can be stacked on top of one another and rotate around the same rotary shaft (e.g., rotary shaft 209 and 219 are the same rotary shaft or portions of the same rotary shaft) and targets 208, 218 can be the same conductive target.

In an aspect, receiver coils in each inductive sensor can have its own electrical signal periods per rotation (herein referred to as “period” for simplicity) denoted as N. The electrical signal periods per rotation can be the number of electrical signals bring provided by the inductive sensor to inductive sensor IC per rotation of the inductive sensor. For example, cosine RX coil 104 and sine RX coil 106 can have the period N1 and cosine RX coil 114 and sine RX coil 116 can have the period N2. If N1=N2, then voltages picked up by one of inductor sensors 101, 111 can be used by inductive sensor IC 110 for measurement and the voltages picked up by the other one of inductor sensors can be used by inductive sensor IC 110 for safety mechanism such as fail-safe or error detection.

In an aspect, the receiver coils in inductive sensors 101 and the receiver coils in inductive sensors 111 can have same or different number of coil turns. The number of coil turns of inductive sensors 101, 111 being same or different can be dependent on the coil design and/or the desired ratio of electrical signal periods per rotation between inductive sensors 101, 111. For example, in an example embodiment shown in FIG. 2B, inductive sensors 101, 111 with Vernier ratio of N to N−1 is shown. In the example embodiment shown in FIG. 2B, the receiver coils of inductive sensor 101 can have N periods (N1=N) and the receiver coils of inductive sensor 101 can have N−1 periods (N2=N−1). The number of coil turns in inductive sensors 101, 111 can be defined to ensure that the period ratio of inductive sensors 101, 111 is the Vernier ratio N to N−1.

In the embodiment shown in FIG. 2B, targets 208, 218 of inductive sensors 101, 111 having the Vernier ratio can be mounted on different gears 222, 224, respectively, where gears 222, 2224 have different number of teeth. A main gear 220 can be coupled to gears 222, 224 such that when main gear 220 rotates, gears 222, 224 can also rotate targets 208, 218. As gears 222, 224 move, the angle positions of the targets 208, 218 relative to the receiver coils of inductive sensors 101, 111 can also change. The changes in the angle positions can cause secondary voltages picked up by receiver coils of inductive sensors 101, 111 to change as well. The embodiment shown in FIG. 2B can have a physical component attached to the main gear 220 such that inductive sensor IC 110 can convert the secondary voltages picked up by inductive sensors 101, 111 into digital signals. Controller 120 can use the digital signals to determine a position of the physical component attached to main gear 220. In one example embodiment, N1 can be 16 periods, N2 can be 15 periods, main gear 220 can include 60 teeth, gear 222 can include 30 teeth and gear 224 can include 32 teeth, and 4 rotations of main gear 220 is equivalent to 8 rotations of gear 222 and 7.5 rotations of gear 224.

In another example embodiment shown in FIG. 2C, inductive sensors 101, 111 with an absolute ratio of N to 1 is shown. In the example embodiment shown in FIG. 2C, the receiver coils of inductive sensor 101 can have N periods (N1=N) and the receiver coils of inductive sensor 101 can have a periods of 1, or one electrical signal per rotation (N2=1). The number of coil turns in inductive sensors 101, 111 can be defined to ensure that the period ratio of inductive sensors 101, 111 is the absolute ratio N to 1. In the embodiment shown in FIG. 2C, target 208 can include 4 pieces of conductive targets and target 218 can include 1 piece of conductive target. Cosine RX coil 104 and sine RX coil 106 can encompass or surround cosine RX coil 114 and sine RX coil 116 while being printed on the same PCB. TX coil 102 can encompass or surround cosine RX coil 104 and sine RX coil 106 and can be printed on the same PCB as well. Hence, coils 102, 104, 106, 114, 116 can be printed on the same PCB. Targets 208, 218 of inductive sensors 101, 111 having the absolute ratio can be mounted on different gears for rotating targets 208, 218. In one example embodiment, N1 can be 4 periods and N2 can be 1 period. In one embodiment, when the inductive sensors 101, 111 having absolute ratio of N to 1 is implemented in high resolution motor commutation sensors, secondary voltages picked up by both inductive sensors 101, 111 can be used for measurement (e.g., determining position) and also used for safety mechanism such as plausibility checks.

In another example embodiment shown in FIG. 2D, inductive sensors 101, 111 with an absolute ratio of N to M is shown, where N and M can be the same or can be different depending on a desired implementation. In one embodiment, inductive sensors 101, 111 can have the same signal periods (e.g., N=M) but have inverse rotation (e.g., rotate in opposite directions) and out of phase with each other. In the example embodiment shown in FIG. 2D, the receiver coils of inductive sensor 101 can have N periods (N1=N) and the receiver coils of inductive sensor 101 can have M periods (N2=M). The number of coil turns in inductive sensors 101, 111 can be defined to ensure that the period ratio of inductive sensors 101, 111 is the ratio N to M. In the embodiment shown in FIG. 2D, 4 pieces of conductive targets can be rotated above the receiver coils of inductive sensors 101, 111. Cosine RX coil 104, sine RX coil 106 and cosine RX coil 114, sine RX coil 116 can be printed on the same PCB and can intertwined with one another. TX coil 102 can encompass or surround the receiver coils and can be printed on the same PCB as well. Hence, coils 102, 104, 106, 114, 116 can be printed on the same PCB. In one example embodiment, N1 can be 4 periods and N2 can also be 4 periods. In another embodiment, N1 can be 5 periods and N2 can also be 6 periods for inductive position sensing for brake pedals in a vehicle.

In one embodiment, the redundant receiver coils described herein (FIG. 2B, 2C, 2D, or the like) can be mechanically linked with a fixed relation. The fixed relation can be used by controller 120 for plausibility checks. Note that some conventional plausibility checks are typically performed on the same angles, such as determining whether there is a difference in measurement between the same position angles from the redundant coils. The plausibility check described herein can check for errors despite the two redundant coils having different configurations, such as different number of periods, different rotation direction, phase shifts, or the like, because the plausibility checks described herein utilizes a fixed relation between the redundant coils. Hence, the plausibility checks described herein can provide relatively more flexibility in system design (e.g., the redundant coils need not to be identical) while achieving high levels of safety requirements. In one embodiment, the fixed relation for mechanically linking the redundant receiver coils can be based on the redundant coils' design, such as the number of coil turns in each one of inductive sensors 101, 111. For example, the redundant receiver coils' fixed relation to achieve a Vernier ratio N to N−1 for period of inductive sensors 101, 111 can be expressed as the following modulus functions:

$$MOD ( φ2 ; 2 π ) = MOD ( ϕ1 N / ( N - 1 ) ; 2 π )$$

$$MOD ( φ 1 ; 2 π ) = MOD ( ϕ2 ( N - 1 ) / N ; 2 π )$$

where φ1 is the digital format of the angle position of at least one target (e.g., 108, 208 and/or 218) relative to RX coils 104, 106 and 42 is the digital format of the angle position of at least one target (e.g., 108, 208 and/or 218) relative to RX coils 114, 116. In one embodiment, the value of N and the fixed relation between inductive sensors 101, 111 can be stored or preset in inductive sensor IC 110. Inductive sensor IC 110 can provide the value of N and the fixed relation to controller 120 to cause controller 120 to perform plausibility checks using digital parameters φ1 and 42.

In another embodiment, the fixed relation for mechanically linking the redundant receiver coils can be a mechanical relation that achieves a desired period ratio. For example, inductive position sensors implementing steering angle sensors can use two identical coil designs (e.g., same number of coil turns) that translate with the mechanical gears (e.g., gears 222, 224) into 16 (e.g., N) and 15 (e.g., N−1) electrical signal periods. The fixed relation between the two inductive sensors can be used by controller 120 for performing plausibility checks. For example, in systems with the receiver coils having the Vernier ratio, inductive sensor IC 110 can provide the values of 41 and φ2, and/or the fixed relation, to controller 120 to check whether the values of 41 and 42 satisfy the modulus functions presented above.

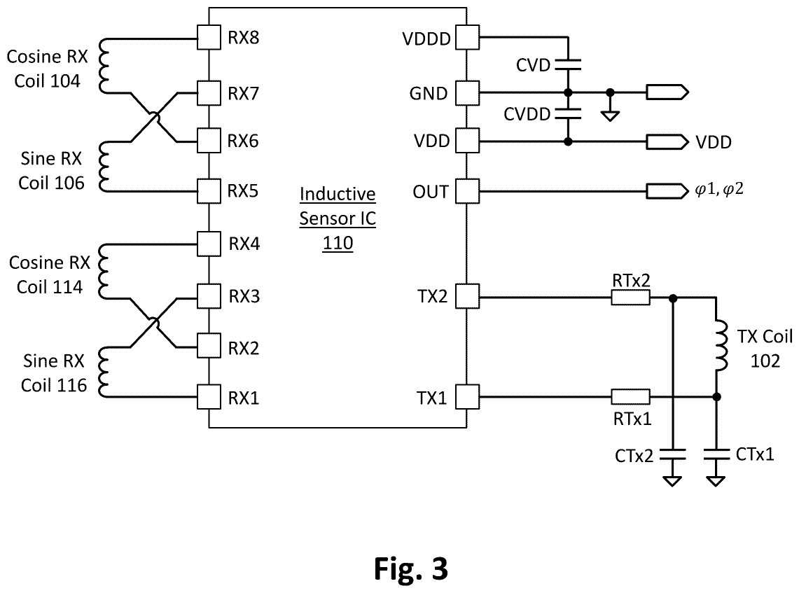

FIG. 3 is a diagram showing details of an integrated circuit for redundant inductive sensor coils in one embodiment. Descriptions of FIG. 3 can reference components shown in FIG. 1 to FIG. 2D. In an example embodiment shown in FIG. 3, inductive sensor IC 110 can include input pins RX1 to RX8 configured to receive voltage signals 109c, 109s, 119c, 119s from the RX coils 104, 106, 114, 116. Output pins TX1, TX2 can be configured to output a signal (e.g., signal 103) to TX coil 102. Voltage supply pins VDDD and VDD can receive voltage supply of different voltage levels, such as 3.3 volts (V)+0.3V or 5.0V+0.5V. GND pin can connect inductive sensor IC 110 to ground. An I/O pin IO1 can be configured to receive signals from an I2C communication bus, or configured as an analog input (AIN) pin to receive analog signals such as external sensors including temperature and/or humidity sensors. Inductor sensor IC 110 can include at least one output pin OUT. The OUT pin can be configured to output various signals such as digital signals φ1 and φ2.

Inductive sensor 110 shown in FIG. 3 can be compliant with the ISO26262 functional safety requirements up ASIL D. In an aspect, conventional systems including redundant receiver coils for the purpose of being compliant up to ASIL D requires two separate signal conditioning circuits or IC to process voltages from the redundant receiver coils (e.g., one chip or IC for each gear) because each set of receiver coils (e.g., cosine and sine receiver coils) are typically integrated with one IC. As described and shown in the present disclosure, since the receiver coils 104, 106, 114, 116 are printed on a PCB outside of inductive sensor IC 110, a single signal conditioning circuit, such as inductive sensor IC 110, can process the voltages from both sets of receiver coils (e.g., both inductive sensors 101, 111).

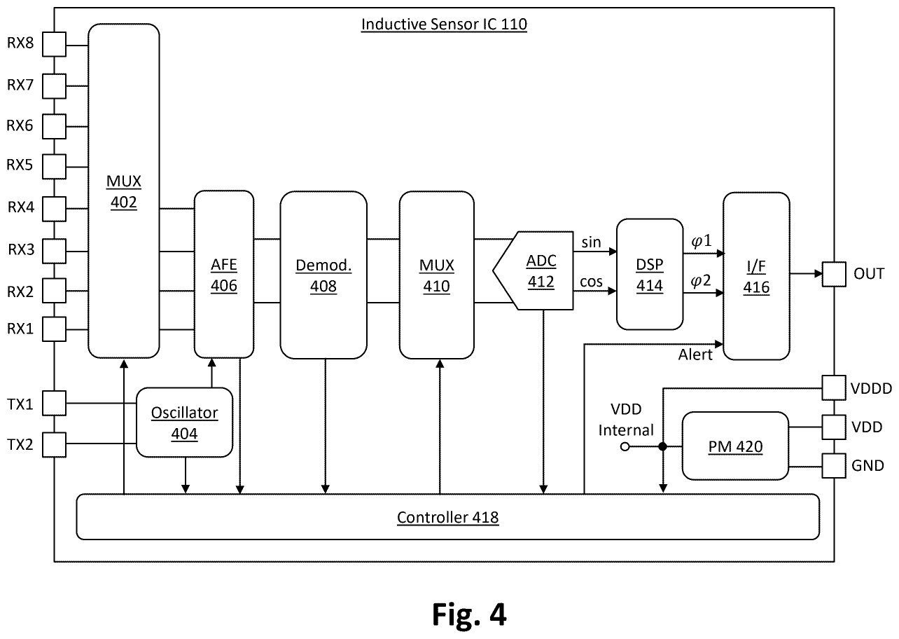

FIG. 4 is a diagram showing additional details of an integrated circuit for redundant inductive sensor coils in one embodiment. Descriptions of FIG. 4 can reference components shown in FIG. 1 to FIG. 3. In an example embodiment shown in FIG. 4, inductive sensor IC 110 can include an input multiplexer (MUX) labeled as MUX 402, an oscillator 404, an analog front end (AFE) 406, demodulator (Demod.) 408, a MUX 410, an analog-to-digital converter (ADC) 412, a digital signal processor 414, an output interface (I/F) 416, a controller 418 and a power management circuit PM 420. PM 420 can be configured to manage power being distributed to different components of inductive sensor IC 110. Oscillator 404 can generate a radio-frequency signal for TX coil 102 to generate a high frequency magnetic field that can be picked up by inductive sensors 101, 111. MUX 402 can receive voltage signals 109c, 109s, 119c, 119s through the pins RX1 to RX8.

MUX 402 can select either one of 1) voltage signals 109c, 109s through pins RX5 to RX8, or 2) voltage signals 119c, 119s through pins RX1 to RX4. In one embodiment, controller 418 can be configured to provide selection signals to MUX 402 in order for MUX 402 to select output voltages received at pins RX5 to RX8, or pins RX1 to RX4. In one embodiment, the selection signals can cause MUX 402 to alternately select 1) pins RX1 to RX4 and 2) pinsRX5 to RX8. The alternate selection by the selections signals from controller 418 can time multiplex the voltage signals being provided by inductive sensors 101, 111. The time multiplexing can allow a single signal conditioning IC (inductive sensor IC 110) to be used for processing one set of voltage signals from the redundant inductive sensors 101, 111, using one channel, or one integrated signal path in inductive sensor IC 110, at a time.

AFE 406 can include various analog circuit components for processing the voltage signals selected by MUX 402, such as filters for filtering noise from the voltage signals. AFE 406 can provide the processed analog signals to demodulator 408 and demodulator 408 can demodulate the processed analog signals. The demodulated analog signals can be provided to MUX 410 and MUX 410 can select the demodulated analog signals sequentially such that ADC 412 can convert the demodulated analog signals into digital signals serially. In another embodiment (not shown), the demodulated analog signals from demodulator 408 can be provided to a parallel input ADC for converting the demodulated analog signals into digital signals.

The digital signals being outputted by ADC 412 can include a first digital signal (“sin” in FIG. 4″) representing voltage signal provided by a sine RX coil, such as voltage signal 109s or 119s, and a second digital signal (“cos” in FIG. 4″) representing voltage signal provided by a cosine RX coil, such as voltage signal 109c or 119c. The digital signals can be provided to DSP 414 and DSP 414 can convert the digital signals into digital parameters φ1, φ2. The digital parameters φ1, φ2 can be provided to output I/F 416 for outputting digital parameters φ1, φ2 to controller 120 via the OUT pin.

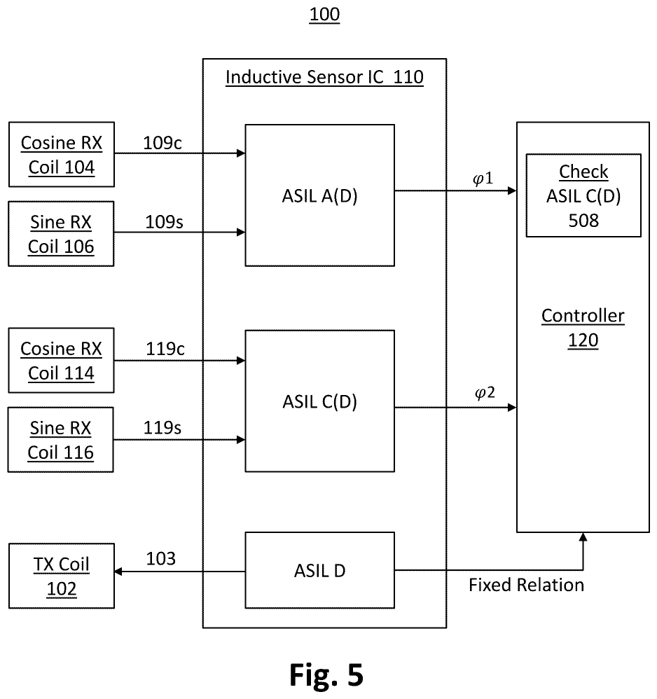

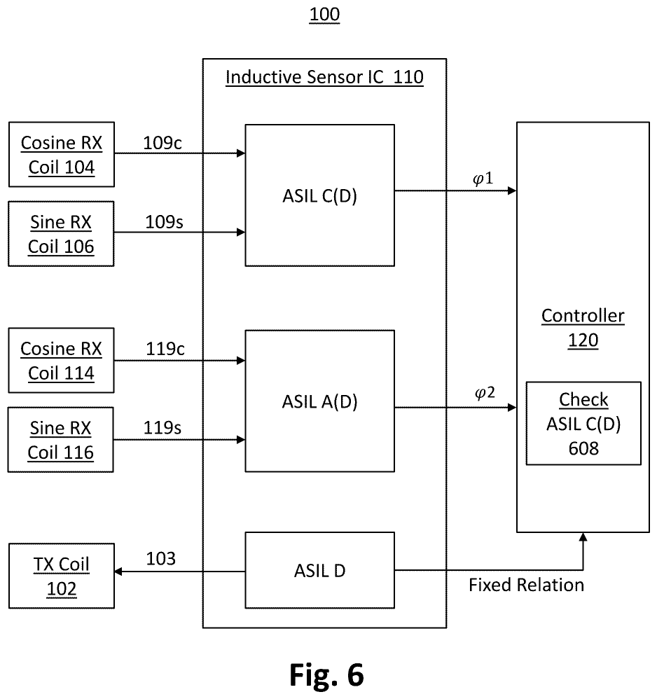

FIG. 5 and FIG. 6 are diagrams showing ASIL D decompositions that can be achieved by integrated circuit for redundant inductive sensor coils in one embodiment. Descriptions of FIG. 5 and FIG. 6 can reference components shown in FIG. 1 to FIG. 4. In an aspect, ASIL A corresponds to a correct detection of angle positions by an inductive sensor (e.g., inductive sensors 101, 111) and correct transmission of the detected angle positions from the inductive sensor to a signal conditioning circuit (e.g., inductive sensor IC 110). ASIL C corresponds to integrity check and confirmation of detection and transmission of the angle positions. Thus, to achieve ASIL C, a component needs to be configured to perform integrity check on the detected and transmitted angle positions. ASIL D corresponds to using redundant components to perform safety mechanisms. Therefore, ASIL D can be decomposed into ASIL A (D) and ASIL C (D) since the correct detection of angle positions along with integrity check can be deemed as using redundancy for safety mechanisms. Further, inductive sensor IC 110 can be configured to perform safety mechanism to ensure that TX coil 102 is being correctly excited by signal 103. (e.g., ensuring integrity of signal 103). The safety mechanism for ensuring integrity of signal 103 can achieve ASIL D as well.

Inductive sensor IC 110 can use voltages from one of the inductive sensors 101, 111 for measurement and use voltages from the other one of inductive sensors 101, 111 for safety mechanism. In an embodiment shown in FIG. 5, inductive sensor IC 110 can use voltage signals 109c, 109s from inductive sensor 101 for measurement and use voltage signals 119c, 119s from inductive sensor 111 for safety mechanism. Inductive sensor IC 110 can convert voltage signals 109c, 109s into digital parameter φ1 and convert voltage signals 119c, 119s into digital parameter φ2. Inductive sensor IC 110 can send digital parameters φ1, φ2 to controller 120 to trigger a plausibility checker 508. In response to receiving digital parameters φ1, φ2 controller 120 can use digital parameters φ1, φ2 and fixed relation between inductive sensors 101, 111 to run plausibility checker 508. Plausibility checker 508 can run a plausibility check for determining whether the detected angle positions are correctly detected and transmitted. By way of example, since inductive sensor 101 is being use for measurement and inductive sensor 111 is being use for safety mechanism, plausibility checker 508 can execute instructions 126 stored in memory 124 that checks a validity of the modulus function MOD(φ2; 2π)=MOD(φ1 N/(N−1); 2π) to determine whether the digital parameter φ2 forms a valid combination with the digital parameter φ1. In the embodiment shown in FIG. 5, plausibility checker 508 can be implemented by hardware (e.g., application specific integrated circuit (ASIC)), software, or a combination of both, that achieves ASIL C (D) requirements.

In an embodiment shown in FIG. 6, inductive sensor IC 110 can use voltage signals 119c, 119s from inductive sensor 111 for measurement and use voltage signals 109c, 109s from inductive sensor 101 for safety mechanism. Inductive sensor IC 110 can convert voltage signals 109c, 109s into digital parameter φ1 and convert voltage signals 119c, 119s into digital parameter φ2. Inductive sensor IC 110 can send digital parameters φ1, φ2 to controller 120 to trigger a plausibility checker 608. In response to receiving digital parameters φ1, φ2 controller 120 can use digital parameters φ1, φ2 and fixed relation between inductive sensors 101, 111 to run plausibility checker 608. Plausibility checker 608 can determine whether the detected angle positions are correctly detected and transmitted. By way of example, since inductive sensor 111 is being use for measurement and inductive sensor 101 is being use for safety mechanism, plausibility checker 608 can execute instructions 126 stored in memory 124 that checks a validity of the modulus function MOD(φ1; 2π)=MOD(φ2 (N−1)/N; 2π) to determine whether the digital parameter φ1 forms a valid combination with the digital parameter φ2. In the embodiment shown in FIG. 6, plausibility checker 608 can be implemented by hardware (e.g., ASIC), software, or a combination of both, that achieves ASIL C (D) requirements

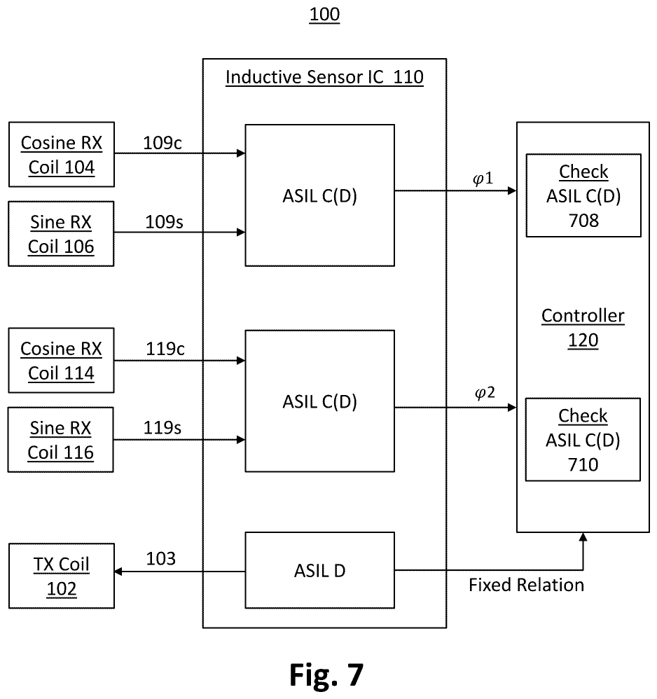

FIG. 7 is a diagram showing another ASIL D decomposition that can be achieved by integrated circuit for redundant inductive sensor coils in one embodiment. Descriptions of FIG. 7 can reference components shown in FIG. 1 to FIG. 6. In an aspect, ASIL D can be decomposed into two ASIL C (D) since redundancy of integrity checks can achieve ASIL D's redundancy requirement. In an embodiment shown in FIG. 7, inductive sensor IC 110 can use voltage signals 109c, 109s from inductive sensor 101 and voltage signals 119c, 119s from inductive sensor 111 for both measurement and safety mechanism. Inductive sensor IC 110 can convert voltage signals 109c, 109s into digital parameter φ1 and convert voltage signals 119c, 119s into digital parameter φ2. Inductive sensor IC 110 can send digital parameters φ1, φ2 to controller 120 to trigger plausibility checkers 708, 710. In response to receiving digital parameters φ1, φ2 controller 120 can use digital parameters φ1, φ2 and fixed relation between inductive sensors 101, 111 to run plausibility checkers 708, 710. Plausibility checker 708 can run a plausibility check for determining whether the detected angle positions based on voltage signals 109c, 109s are correctly detected and transmitted. Plausibility checker 710 can run a plausibility check for determining whether the detected angle positions based on voltage signals 119c, 119s are correctly detected and transmitted. Plausibility checker 708 can execute instructions 126 that checks a validity of the modulus function MOD(φ2; 2π)=MOD(φ1 N/(N−1); 2π) to determine whether the digital parameter φ2 forms a valid combination with the digital parameter φ1. Plausibility checker 710 can execute instructions 126 that checks a validity of the modulus function MOD(φ1; 2π)=MOD(φ2 (N−1)/N; 2π) to determine whether the digital parameter φ1 forms a valid combination with the digital parameter φ2. In the embodiment shown in FIG. 7, plausibility checkers 708, 710 can be implemented by hardware (e.g., application specific integrated circuit (ASIC)), software, or a combination of both, that achieves ASIL C (D) requirements

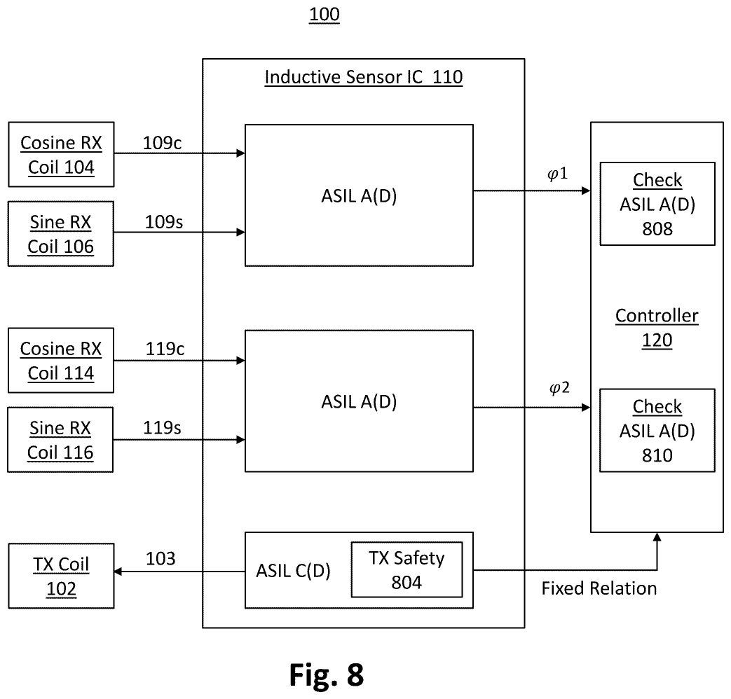

FIG. 8 is a diagram showing another ASIL D decomposition that can be achieved by integrated circuit for redundant inductive sensor coils in one embodiment. Descriptions of FIG. 8 can reference components shown in FIG. 1 to FIG. 7. In an aspect, ASIL C can be decomposed into two ASIL A (D) since redundancy of confirming correct detection and transmission of angle positions can achieve the integrity check requirement of ASIL C. Since ASIL D can be decomposed into two ASIL C (D), and ASIL C can be decomposed into two ASIL A (D), ASIL D can be decomposed into two ASIL A (D) and one ASIL C (D). Hence, the control of TX coil 102 can be implemented by an ASIL C (D) component that can perform a TX safety mechanism 804 without using redundant hardware components to control TX coil 102. In one embodiment, the TX safety mechanism 804 can include a frequency counter configured to check if the TX coil 102 is operating within an expected or predefined frequency range. In an embodiment shown in FIG. 8, inductive sensor IC 110 can use voltage signals 109c, 109s from inductive sensor 101 and voltage signals 119c, 119s from inductive sensor 111 for both measurement and safety mechanism. Inductive sensor IC 110 can convert voltage signals 109c, 109s into digital parameter φ1 and convert voltage signals 119c, 119s into digital parameter φ2. Inductive sensor IC 110 can send digital parameters φ1, φ2 to controller 120 to trigger plausibility checkers 808, 810. In response to receiving digital parameters φ1, φ2 controller 120 can use digital parameters φ1, φ2 and fixed relation between inductive sensors 101, 111 to run plausibility checkers 808, 810. Plausibility checker 808 can run a plausibility check for determining whether the detected angle positions based on voltage signals 109c, 109s are correctly detected and transmitted. Plausibility checker 810 can run a plausibility check for determining whether the detected angle positions based on voltage signals 119c, 119s are correctly detected and transmitted. Plausibility checker 808 can execute instructions 126 that checks a validity of the modulus function MOD(φ2; 2φ)=MOD(φ1 N/(N−1); 2π) to determine whether the digital parameter φ2 forms a valid combination with the digital parameter φ1. Plausibility checker 810 can execute instructions 126 that checks a validity of the modulus function MOD(φ1; 2π)=MOD(φ2 (N−1)/N; 2π) to determine whether the digital parameter φ1 forms a valid combination with the digital parameter φ2. In the embodiment shown in FIG. 8, plausibility checkers 808, 810 can be implemented by hardware (e.g., application specific integrated circuit (ASIC)), software, or a combination of both, that achieves ASIL A (D) requirements

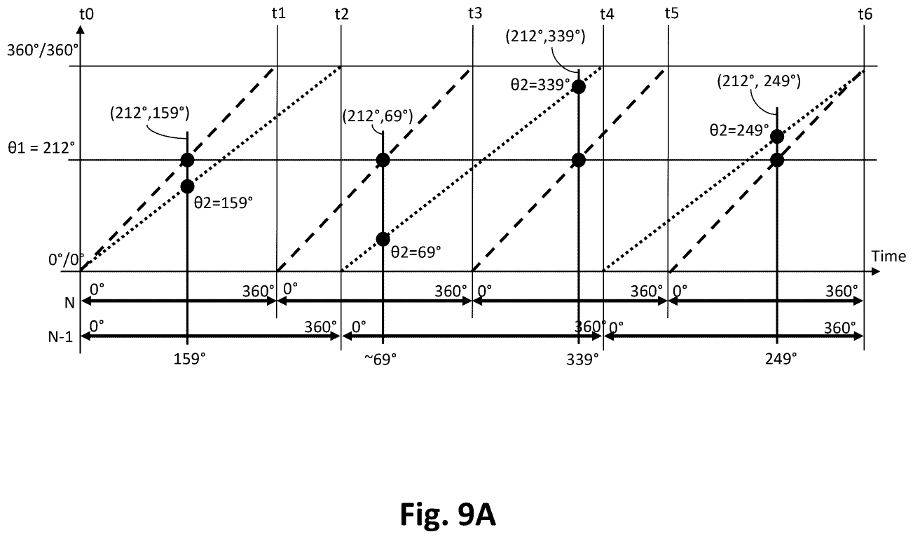

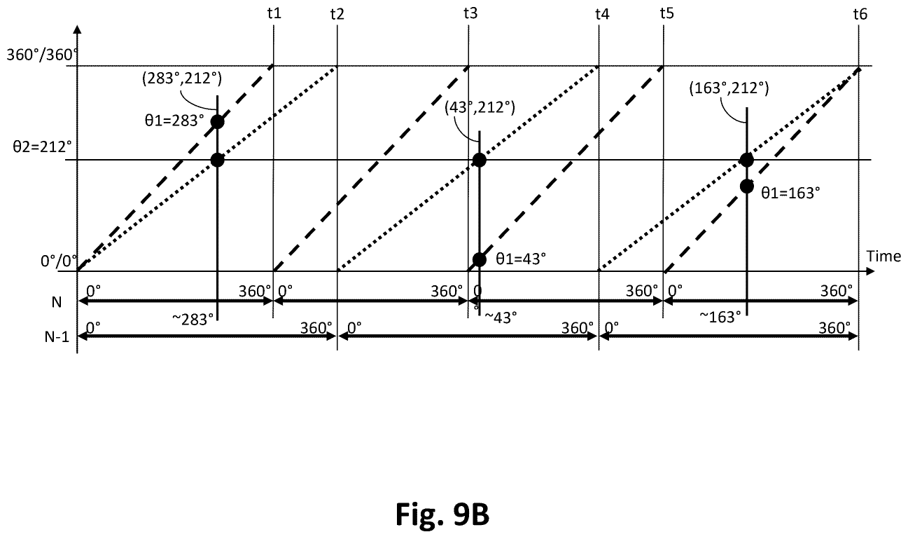

FIG. 9A is a diagram showing an example of combinations of target position angles for an implementation of redundant inductive sensor coils in one embodiment. Descriptions of FIG. 9A can reference components shown in FIG. 1 to FIG. 8. In one embodiment, inductive sensor 101 can be a rotary sensor having N signal periods and inductive sensor 111 can be another rotary sensor having N−1 signal periods. An angle position of a target relative to RX coils 104, 106 of inductive sensor 101 can be denoted as an angle θ1 and an angle position of the target relative to RX coils 114, 116 of inductive sensor 111 can be denoted as an angle θ2. Voltages picked up from inductive sensors 101, 111 can be dependent on angles θ1, 02, and inductive sensor IC 110 can convert the voltages picked up from inductive sensors 101, 111 into the digital parameters φ1, φ2. Hence, the digital parameter φ1 can be a digital representation of angle θ1 and the digital parameter φ2 can be a digital representation of angle θ2.

Inductive sensor IC 110 can provide the digital parameters φ1, φ2 to controller 120 to trigger plausibility checkers (e.g., 508, 608, 708, 710, 808, 810 described above). The plausibility checker can convert the digital parameters φ1, φ2 to angles θ1, θ2 and determine whether θ1, θ2 satisfy the fixed relation or not. By way of example, a pair of angles (θ1, θ2), which is digitized to (φ1, φ2), satisfying the modulus functions MOD(φ2; 2π)=MOD(φ1 N/(N−1); 2π) and MOD(φ1; 2π)=MOD(φ2 (N−1)/N; 2π) can be considered as a valid combination. A pair of angles (θ1, θ2) that do not satisfy the modulus functions MOD(φ2; 2π)=MOD(φ1 N/(N−1); 2π) and MOD(φ1; 2π)=MOD(φ2 (N−1)/N; 2π) can be considered as an invalid combination. If the plausibility check indicates the pair of angles (θ1, θ2) are a valid combination, then the result of the plausibility check can indicate that the redundant inductive sensors performed both measurement and safety mechanism correctly. If the plausibility check indicates the pair of angles (θ1, θ2) are an invalid combination, then the result of the plausibility check can indicate that either the measurement or the safety mechanism are incorrect and corrective actions may be required.

In an example shown in FIG. 9A, inductive sensors 101, 111 can have the signal period ratio of N to N−1, where a gear mounted with inductive sensor 101 can complete 4 (N=4) signal periods and a gear mounted with inductive sensor 111 can complete 3 (N−1=3) signal periods at a time t6. Note that since the gears mounted with inductive sensors 101, 111 are of different sizes (e.g., different number of teeth), the pairing of angles θ1, θ2 can vary over different signal periods. For example, in a first signal period of the gear with N signal periods between time to and t1, when θ1=212°, the corresponding θ2=159° and the gear with N−1 signal periods is also in its first signal period (between time t0 and t2). In a second signal period of the gear with N signal periods between time t1 and t3, when θ1=212°, the corresponding θ2=69° and the gear with N−1 signal periods is also in its second signal period (between time t2 and t4). In a third signal period of the gear with N signal periods between time t3 and t5, when 01=212°, the corresponding θ2=339° and the gear with N−1 signal periods is still in its second signal period (between time t2 and t4). Therefore, when θ1=212°, the only angle values of θ2 that will result in a valid combination under the plausibility check are 159°, 69°, 339° and 249°. If θ1=212° but θ2 is a value other than 159°, 69°, 339° and 249°, then the pair (θ1, θ2) are considered as invalid. In another example shown in FIG. 9B, when θ2=212°, the only angle values of θ1 that will result in a valid combination under the plausibility check are 283°, 43°, and 163°. If θ2=212° but 01 is a value other than 283°, 43°, and 163°, then the pair (θ1, θ2) are considered as invalid.

If the plausibility check indicates the pair of angles (θ1, θ2) are a valid combination, then the result of the plausibility check can indicate that there may be no errors, such as no discrepancies between the measurement of voltages being picked up by both of the redundant inductive sensors. If the plausibility check indicates the pair of angles (θ1, θ2) are an invalid combination, then the result of the plausibility check can indicate that there may be errors, such as presence of discrepancies between the measurement of voltages being picked up between the redundant inductive sensors. Thus, the inductive sensor IC 110 multiplexing the voltages being picked up by the redundant receiver coils, generating and providing digital parameters φ1, φ2for controller 120, and triggering the plausibility checker(s), can implement a system that can achieve ASIL D's redundancy requirement with safety mechanism without using redundant signal conditioning ICs.

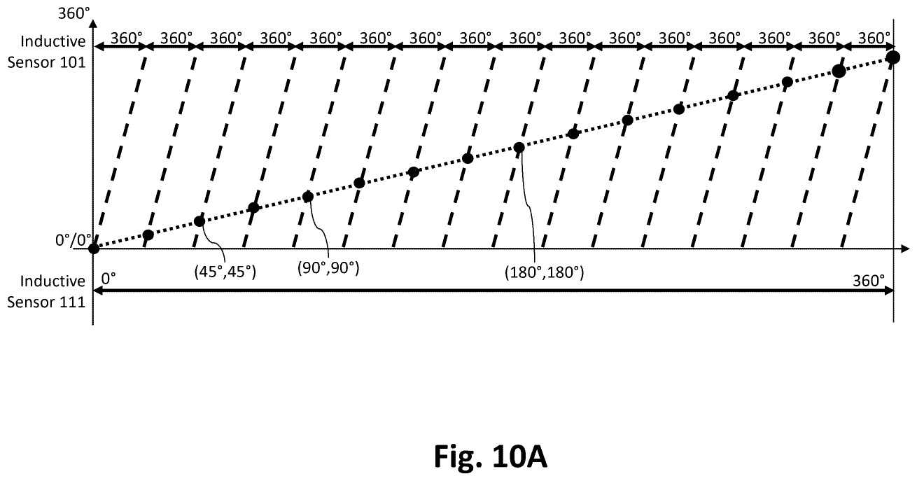

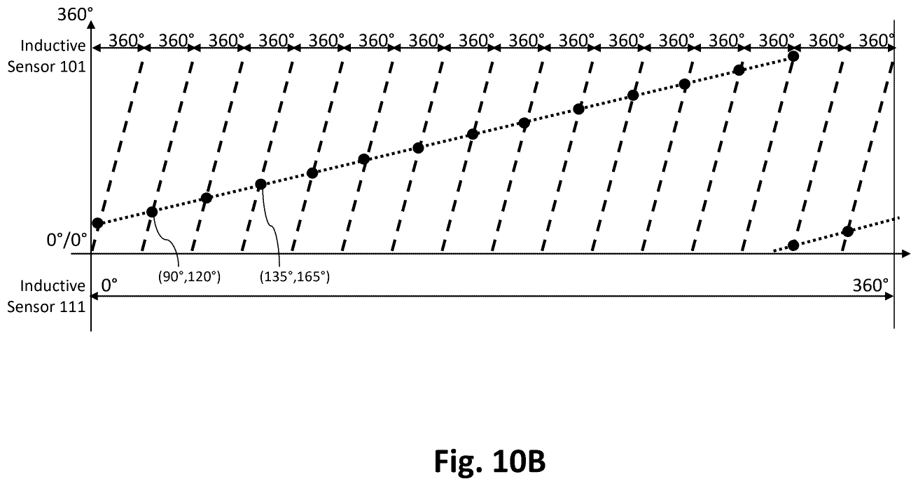

FIG. 10A is a diagram showing an example of a plausibility check based on integrated circuit for redundant inductive sensor coils in one embodiment. Descriptions of FIG. 10A can reference components shown in FIG. 1 to FIG. 9B. In one embodiment, inductive sensor 101 can be a rotary sensor having N signal periods and inductive sensor 111 can be another rotary sensor having 1 signal period. The plausibility check being performed by The plausibility checker can identify whether voltages picked up by inductive sensors 101, 111 result in valid or invalid combinations of the pair (θ1, θ2). By way of example, for gears with N:1 ratio, a pair of angles (θ1, θ2), which is digitized to (φ1, φ2), satisfying the modulus functions MOD(φ2; 2π)=MOD(φ1/N; 2π) and MOD(φ1; 2π)=MOD(φ2*N; 2π) can be considered as a valid combination. As shown in FIG. 10A, some valid combinations of the gears with N:1 ratio include (45°, 45°), (90°, 90°) and (180°, 180°). Note that the example shown in FIG. 10A corresponds to a sub-optimal configuration where the channels for inductive sensors 101, 111 uses the same nominal angle, thus the valid combinations of the pair (θ1, θ2) tends to be identical angles. In another example shown in FIG. 10B, some valid combinations of the gears with N:1 ratio include (90°, 120°) and (135°, 165°). The example shown in FIG. 10B corresponds to an optimal configuration where the channels for inductive sensors 101, 111 uses different nominal angles.

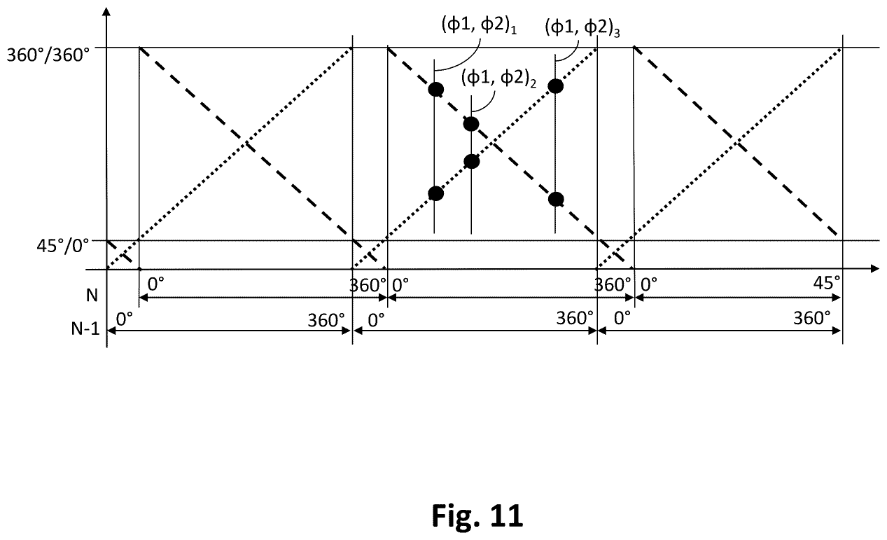

FIG. 11 is a diagram showing an example of a plausibility check based on integrated circuit for redundant inductive sensor coils in one embodiment. Descriptions of FIG. 11 can reference components shown in FIG. 1 to FIG. 10B. In one embodiment, both of inductive sensors 101, 111, or a sensor configuration as shown in FIG. 2D, can be rotary sensors having N signal periods (e.g., same signal period) but with but inverse rotation and out of phase (e.g., one of the two sets of receiver coils is phase shifted). In the example shown in FIG. 11A, the pair of values (φ1, φ2) does not repeat within a range of 360°. For example, the pair (φ1, φ2)₁, (φ1, φ2)₂, and (φ1, φ2)₃ are not the same.

Computer readable program instructions (e.g., instructions 126) described herein can be downloaded to respective computing/processing devices (e.g., controller 120) from a computer readable storage medium or to an external computer or external storage device via a network, such as the Internet, a local area network, a wide area network and/or a wireless network. Computer readable program instructions for carrying out operations of the present disclosure may include machine instructions, microcode, firmware instructions, state-setting data, configuration data for integrated circuits, or source code, executable code, or object code written in any combination of one or more programming languages. The computer readable program instructions may be executed on a controller or processor, or as a stand-alone software package, or a combination of both. In some embodiments, electronic circuitry including, for example, programmable logic circuitry, field-programmable gate arrays (FPGA), or programmable logic arrays (PLA) may execute the computer readable program instructions by utilizing state information of the computer readable program instructions to perform aspects of the present disclosure.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The disclosed embodiments of the present invention have been presented for purposes of illustration and description but are not intended to be exhaustive or limited to the invention in the forms disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

What is claimed is:

1. A system comprising:
a conductive target;
a transmission coil configured to generate a magnetic field;
a first inductive sensor including a first set of receiver coils configured to pick up a set of first voltage signals from the magnetic field, wherein the set of first voltage signals indicates a first angle position of the conductive target that varies with movement of the conductive target;
a second inductive sensor including a second set of receiver coils configured to pick up a set of second voltage signals from the magnetic field, wherein the set of second voltage signals indicates a second angle position of the conductive target that varies with movement of the conductive target, and the first inductive sensor and the second inductive sensor are related based on a fixed relation; and
an integrated circuit (IC) configured to:
multiplex the set of first voltage signals and the set of second voltage signals to process one of the set of first voltage signals and the set of second voltage signals using one channel at a time;
convert the set of first voltage signals into a first digital parameter;
convert the set of second voltage signals into a second digital parameter; and
output the first digital parameter and the second digital parameter to trigger at least one plausibility checker to determine whether the first angle position and the second angle position satisfy or fail to satisfy the fixed relation.

2. The system of claim 1, wherein:
the first inductive sensor has N signal periods; and
the second inductive sensor has N−1 signal periods.

3. The system of claim 1, wherein:
the first inductive sensor has N signal periods; and
the second inductive sensor has one signal period.

4. The system of claim 1, wherein an arrangement of the first inductive sensor, the second inductive sensor, the IC and the at least one plausibility checker achieves Automotive Safety Integrity Level (ASIL) level D.

5. The system of claim 1, wherein the IC is configured to:
send a signal to the transmission coil to generate the magnetic field; and
perform a safety mechanism to verify signal integrity of the signal being send to the transmission coil.

6. The system of claim 1, wherein the first inductive sensor and the second inductive sensor are mounted on the same printed circuit board (PCB) and the IC is outside of the PCB.

7. The system of claim 1, wherein:
the first angle position and the second angle position satisfy the fixed relation when there is match between the first angle position and the second angle position and at least one valid combination pair of angle positions; and
the first angle position and the second angle position fail to satisfy the fixed relation when there is mismatch between the first angle position and the second angle position and at least one valid combination pair of angle positions.

8. An integrated circuit comprising:
a multiplexer configured to multiplex a set of first voltage signals and a set of second voltage signals to process one of the set of first voltage signals and the set of second voltage signals using one channel at a time, wherein:
the set of first voltage signals is picked up by a first inductive sensor and indicates a first angle position of a conductive target;
the set of second voltage signals is picked up by a second inductive sensor and indicates a second angle position of the conductive target; and
the first inductive sensor and the second inductive sensor are related based on a fixed relation;
an analog to digital converter (ADC) configured to:
convert the set of first voltage signals into a first digital parameter; and
convert the set of second voltage signals into a second digital parameter; and
an output interface configured to output the first digital parameter and the second digital parameter to trigger at least one plausibility checker to determine whether the first angle position and the second angle position satisfy or fail to satisfy the fixed relation.

9. The integrated circuit of claim 8, wherein:
the first inductive sensor has N signal periods; and
the second inductive sensor has N−1 signal periods.

10. The integrated circuit of claim 8, wherein:
the first inductive sensor has N signal periods; and
the second inductive sensor has one signal period.

11. The integrated circuit of claim 8, wherein:
each one of the first inductive sensor and the second inductive sensor has N signal periods; and
the first inductive sensor and the second inductive sensor have reverse rotation and out of phase.

12. The integrated circuit of claim 8, wherein an arrangement of the first inductive sensor, the second inductive sensor, the integrated circuit and the at least one plausibility checker achieves Automotive Safety Integrity Level (ASIL) level D.

13. The integrated circuit of claim 8, further comprising:
an oscillator configured to send a signal to a transmission coil to generate a magnetic field, wherein the set of first voltage signals and the set of second voltage signals are picked up from the magnetic field; and
a controller configured to perform a safety mechanism to verify signal integrity of the signal being send to the transmission coil.

14. The integrated circuit of claim 8, wherein:
the first angle position and the second angle position satisfy the fixed relation when there is match between the first angle position and the second angle position and at least one valid combination pair of angle positions; and
the first angle position and the second angle position fail to satisfy the fixed relation when there is mismatch between the first angle position and the second angle position and at least one valid combination pair of angle positions.

15. A computer program product for inductive position sensing, the computer program product comprising a computer readable storage medium having program instructions embodied therewith, the program instructions are executable by a processor of a device to cause the device to:
receive a first digital parameter representing a first angle position of a conductive target relative to a first set of receiver coils in a first inductive sensor;
receive a second digital parameter representing a second angle position of the conductive target relative to a second set of receiver coils in a second inductive sensor; and
in response to receipt of the first digital parameter and the second digital parameter, execute a set of instructions to run at least one plausibility checker to determine whether the first angle position and the second angle position satisfies a fixed relation between the first inductive sensor and the second inductive sensor, wherein:
the first angle position and the second angle position satisfying the fixed relation indicates the first angle position and the second angle position are correct; and
the first angle position and the second angle position failing to satisfy the fixed relation indicates one or more of the first angle position and the second angle position are incorrect.

16. The computer program product of claim 15, wherein:
the first inductive sensor has N signal periods; and
the second inductive sensor has N−1 signal periods.

17. The computer program product of claim 15, wherein:
the first inductive sensor has N signal periods; and
the second inductive sensor has one signal period.

18. The computer program product of claim 15, wherein the first digital parameter and the second digital parameter are received from an integrated circuit (IC), and an arrangement of the first inductive sensor, the second inductive sensor, the IC and the at least one plausibility checker achieves Automotive Safety Integrity Level (ASIL) level D.

19. The computer program product of claim 15, wherein the program instructions are executable by the processor of the device to cause the device to:
compare the first angle position and the second angle position to at least one valid combination pairs of angle positions;
determine a match between the first angle position and the second angle position match with one of the at least one valid combination pairs of angle positions; and
in response to determination of the match, determine that the first angle position and the second angle position satisfy the fixed relation.

20. The computer program product of claim 15, wherein the program instructions are executable by the processor of the device to cause the device to:
compare the first angle position and the second angle position to at least one valid combination pairs of angle positions;
determine a mismatch between at least one of the first angle position and the second angle position match with one of the at least one valid combination pairs of angle positions; and
in response to determination of the mismatch, determine that the first angle position and the second angle position fail to satisfy the fixed relation.
